(19) United States
(12) Patent Application Publication
(10) Pub. No.: US 2024/0047796 A1
(43) Pub. Date: Feb. 8, 2024

(54) TOP CAP ASSEMBLY

(71) Applicant: NN, Inc., Charlotte, NC (US)

(72) Inventors: Jeffrey J. Haag, Charlotte, NC (US); Clay A. Edwards, Charlotte, NC (US); David E. Brandeis, Charlotte, NC (US); Christopher T. Mall, Charlotte, NC (US); Hao T. Ngo, Charlotte, NC (US)

(21) Appl. No.: 18/364,063

(22) Filed: Aug. 2, 2023

Related U.S. Application Data
(60) Provisional application No. 63/394,655, filed on Aug. 3, 2022.

(51) Int. Cl. H01M 50/15; H01M 50/557; H01M 50/567; H01M 50/55; H01M 50/342; H01M 50/627

(52) U.S. Cl. CPC H01M 50/15; H01M 50/557; H01M 50/567; H01M 50/55; H01M 50/3425; H01M 50/627

(57) ABSTRACT

A top cap assembly for a battery having a plate, a terminal assembly and a terminal holder. The plate has an aperture for the terminal assembly. The terminal assembly has a terminal cap, a terminal post, and a terminal base. The terminal post is provided within the aperture of the plate, and the terminal cap is provided adjacent a top surface of the plate and is connected to the terminal post. The terminal base is provided adjacent a bottom surface of the plate and is connected to the terminal post. The terminal holder secures the terminal assembly to the plate without having the terminal assembly directly contact the plate.

### CROSS-REFERENCE TO RELATED APPLICATIONS

This application claims the benefit of U.S. Provisional Patent Application No. 63/394,655 filed Aug. 3, 2022, which is expressly incorporated herein by reference and made a part hereof.

### FEDERALLY SPONSORED RESEARCH OR DEVELOPMENT

Not Applicable.

### TECHNICAL FIELD

The present subject matter relates to a top cap assembly, and more particularly, to a top cap assembly for a battery.

### BACKGROUND

Top cap assemblies for batteries are known in the art. While such assemblies according to the prior art provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a top cap assembly for a battery.

The disclosed technology further relates to a top cap assembly for a battery comprising: a plate having a top surface and a bottom surface, the plate having a first aperture for a first terminal assembly and a second aperture for a second terminal assembly, the first aperture extending through the plate from the top surface to the bottom surface, and the second aperture extending through the plate from the top surface to the bottom surface, the plate also having a first raised portion adjacent the first aperture and a second raised portion adjacent the second aperture, the first raised portion and the second raised portion extending away from the top surface of the plate; the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post; a first terminal holder to secure the first terminal assembly to the plate without having the first terminal assembly directly contact the plate, wherein the first terminal holder comprises an overmolded thermoplastic that is overmolded around portions of the first terminal holder and portions of the plate; the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post; and, a second terminal holder to secure the second terminal assembly to the plate without having the second terminal assembly directly contact the plate, wherein the second terminal holder comprises an overmolded thermoplastic that is overmolded around portions of the second terminal holder and portions of the plate.

The disclosed technology further relates to a top cap assembly for a battery comprising: a plate having a top surface and a bottom surface, the plate having a first aperture for a first terminal assembly and a second aperture for a second terminal assembly, the first aperture extending through the plate from the top surface to the bottom surface, and the second aperture extending through the plate from the top surface to the bottom surface; the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post; a first terminal holder to secure the first terminal assembly to the plate without having the first terminal assembly directly contact the plate, wherein the first terminal holder comprises an overmolded thermoplastic that is overmolded around portions of the first terminal holder and portions of the plate; the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post; a second terminal holder to secure the second terminal assembly to the plate without having the second terminal assembly directly contact the plate, wherein the second terminal holder comprises an overmolded thermoplastic that is overmolded around portions of the second terminal holder and portions of the plate; and, wherein the first terminal holder engages the plate, the first terminal cap, the first terminal post, and the first terminal base, and wherein the second terminal holder engages the plate, the second terminal cap, the second terminal post, and the second terminal base.

The disclosed technology further relates to a top cap assembly for a battery comprising: a plate having a top surface and a bottom surface, the plate having a first aperture for a first terminal assembly, the first aperture extending through the plate from the top surface to the bottom surface; the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post; and, a first terminal holder to secure the first terminal assembly to the plate without having the first terminal assembly directly contact the plate, wherein the first terminal holder comprises an overmolded thermoplastic that is overmolded around portions of the first terminal holder and portions of the plate, and wherein the first terminal holder engages the plate, the first terminal cap, the first terminal post, and the first terminal base.

The disclosed technology further relates to a top cap assembly further comprising: the plate having a second aperture for a second terminal assembly, the second aperture extending through the plate from the top surface to the bottom surface; the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post; and, a second terminal holder to secure the second terminal assembly to the plate without having the second terminal assembly directly contact the plate, wherein the second terminal holder comprises an overmolded thermoplastic that is overmolded around portions of the second terminal holder and portions of the plate, wherein the second terminal holder engages the plate, the second terminal cap, the second terminal post, and the second terminal base.

The disclosed technology further relates to a top cap assembly wherein the first terminal holder engages the plate, the first terminal cap, the first terminal post, and the first terminal base, and wherein the second terminal holder engages the plate, the second terminal cap, the second terminal post, and the second terminal base.

The disclosed technology further relates to a top cap assembly further comprising a pressure-relief aperture in the plate extending from the top surface through to the bottom surface, and a rupture disc provided in the pressure-relief aperture and connected to the plate.

The disclosed technology further relates to a top cap assembly wherein the pressure-relief aperture is provided between the first aperture and the second aperture.

The disclosed technology further relates to a top cap assembly further comprising a fill aperture in the plate.

The disclosed technology further relates to a top cap assembly wherein the first and second terminal posts have grooves in an outer surface of each terminal post.

The disclosed technology further relates to a top cap assembly wherein the first terminal cap has an aperture, wherein the first terminal post is provided within the aperture in the first terminal cap and secured to the first terminal cap thereat, wherein the second terminal cap has an aperture, and wherein the second terminal post is provided within the aperture in the second terminal cap and secured to the second terminal cap thereat.

The disclosed technology further relates to a top cap assembly wherein the first terminal post has a cavity, wherein the first terminal base has a post and a flange, wherein the post of the first terminal base fits within the cavity of the first terminal post to connect the first terminal base to the first terminal post, wherein the second terminal post has a cavity, wherein the second terminal base has a post and a flange, wherein the post of the second terminal base fits within the cavity of the second terminal post to connect the second terminal base to the second terminal post.

The disclosed technology further relates to a top cap assembly wherein the first terminal base is made of aluminum, and wherein the second terminal base is made of copper.

The disclosed technology further relates to a top cap assembly wherein the flange of the first terminal base is a distance from the first raised portion of the plate adjacent the first aperture and the flange of the first terminal base is generally flush with a bottom surface of the plate distal the first raised portion, and wherein the flange of the second terminal base is a distance from the second raised portion of the plate adjacent the second aperture and the flange of the second terminal base is generally flush with a bottom surface of the plate distal the second raised portion.

The disclosed technology further relates to a top cap assembly wherein the plate has a first raised portion adjacent the first aperture and a second raised portion adjacent the second aperture, the first raised portion and the second raised portion extending away from the top surface of the plate.

The disclosed technology further relates to a top cap assembly wherein the plate has a first raised portion adjacent the first aperture, the first raised portion extending away from the top surface of the plate.

The disclosed technology further relates to a top cap assembly wherein the flange of the first terminal base is a distance from the first raised portion of the plate adjacent the first aperture and the flange of the first terminal base is generally flush with a bottom surface of the plate distal the first raised portion.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front perspective view of a top cap assembly according to the present disclosure, shown in its environment of use with an exemplary battery.

FIG. 2 is an exploded perspective view of the top cap assembly of FIG. 1.

FIG. 3 is a cross sectional side view of the top cap assembly of FIG. 1 during manufacture, with the top cap assembly in a mold.

FIG. 4 is a cross sectional side view the top cap assembly of FIG. 1.

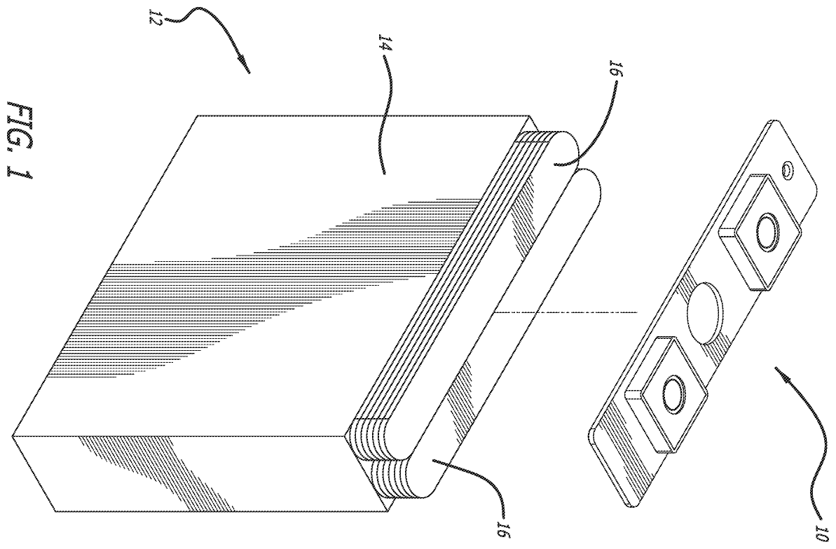

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

Generally, this disclosure describes various embodiments of a top cap assembly 10 for a battery 12. In one embodiment the battery 12 has a housing 14, a plurality of cells 16 and the top cap assembly 10. The cells 16 typically comprise anodes, cathodes, and separators that are typically either sandwiched and rolled up or formed by layer stacking.

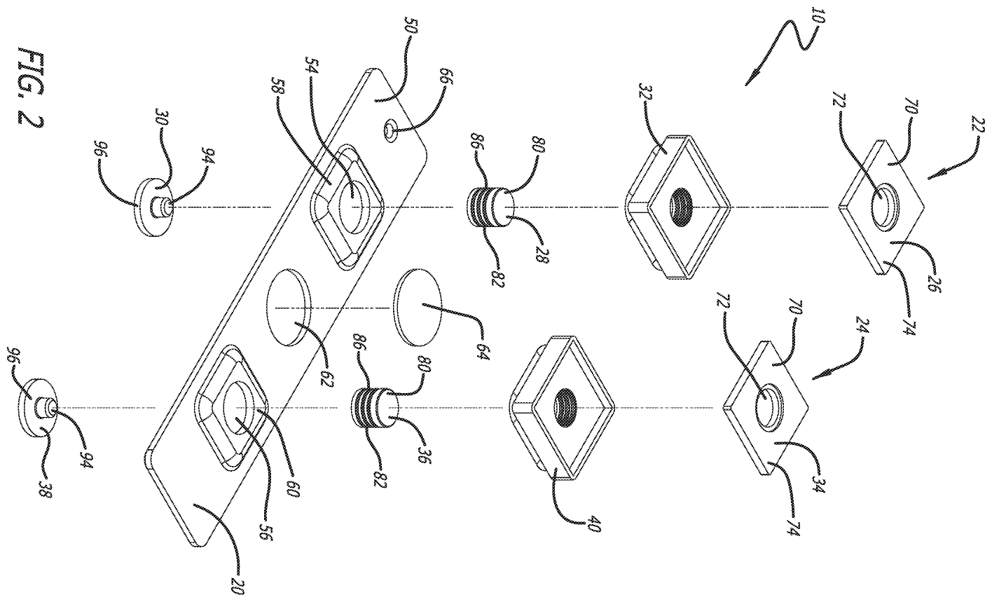

Referring to the figures, and initially to FIG. 2, there is shown one embodiment of a top cap assembly 10. In one embodiment, the top cap assembly 10 comprises a plate 20, a positive terminal assembly 22, and a negative terminal assembly 24.

In one embodiment, the positive terminal assembly 22 generally comprises a positive terminal cap 26, a positive terminal post 28 and a positive terminal base 30. In a preferred embodiment a positive terminal holder 32 or positive terminal shield 32 is also provided as part of the positive terminal assembly 22. In one embodiment, the positive terminal assembly 22 may be referred to as the cathode.

Similarly, in one embodiment, the negative terminal assembly 24 generally comprises a negative terminal cap 34, a negative terminal post 36 and a negative terminal base 38. In a preferred embodiment a negative terminal holder 40 or negative terminal shield 40 is also provided as part of the negative terminal assembly 24. In one embodiment, the negative terminal assembly 24 may be referred to as the anode. In a preferred embodiment, the terminal holders 32, 40 operate as insulators.

In one embodiment, the plate 20 is a metal component, such as aluminum. Further, in one embodiment the plate 20 is made of a stamping. The plate 20 has a first or top surface 50 and a second or bottom surface 52. The plate 20 preferably has a first aperture 54 for the positive terminal assembly 22, and a second aperture 56 for the negative terminal assembly 24. The first and second apertures 54, 56 extend through the plate 20 from the top surface 50 through to the bottom surface 52. The plate 20 may also have a first raised portion 58 adjacent the first aperture 54 and a second raised portion 60 adjacent the second aperture 56. The raised portions 58, 60 extend away from the first or top surface 50 of the plate 20, and may be provided so that upon assembly the terminal bases 30, 38 remain a distance from the plate 20 but are flush with the bottom surface 52 of the plate 20 distal the raised portions 58, 60. Additionally, in one embodiment the plate 20 has a pressure-relief aperture 62 for a rupture disk 64. The pressure—relief aperture 62 extends through from the top surface of the plate to the bottom surface of the plate. The rupture disk 64 may be placed within the pressure-relief aperture 62 and welded to the plate 20. The rupture disk 64 provides over-pressure relief for the battery 12 in the event of an abnormal rise in the internal pressure within the battery 12. In one embodiment the plate 20 also has a fill aperture 66. The fill aperture 66 is provided to allow the battery 12 to be filled with liquid, such as liquid electrolyte, during the final assembly of the battery 12. The fill aperture 66 is then sealed after the battery 12 is filled.

As shown in FIGS. 2-4, in one embodiment, the positive and negative terminal caps 26, 34, generally comprise a small plate 70 with an aperture 72 therethrough. The aperture 72 may be round or it may be some other geometrical shape. The terminal caps 26, 34 have a first or top surface 74 and a second or bottom surface 76. The aperture 72 extends through from the first surface 74 to the second surface 76. In one embodiment the terminal caps 26, 34 are made of aluminum.

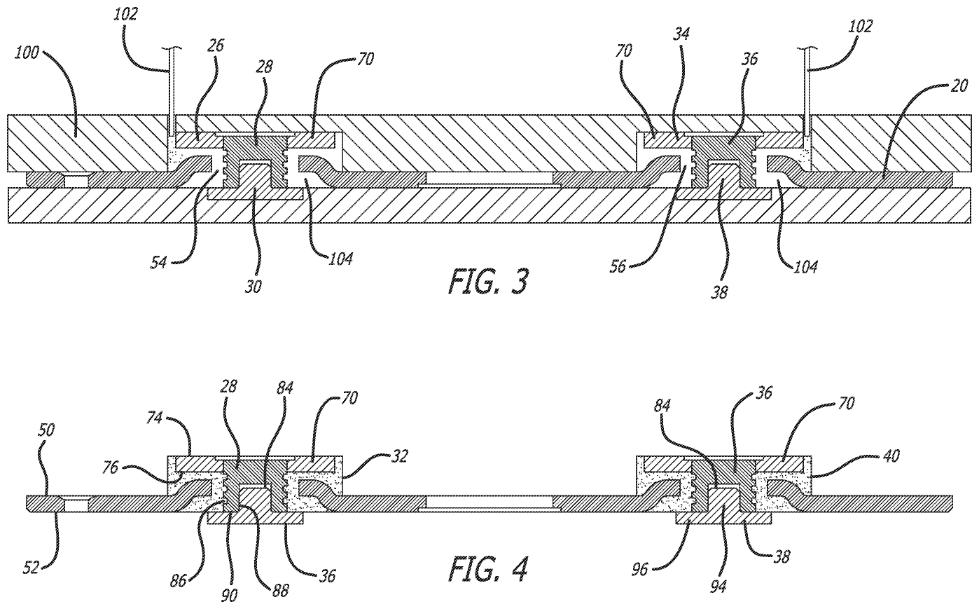

Referring also to FIGS. 2-4, in one embodiment, the positive and negative terminal posts 28, 36 generally comprise a housing 80 having an outer wall 82 and a cavity 84. In a preferred embodiment the outer wall 82 is generally cylindrical, however the outer wall 82 may comprise other geometrical shapes. Preferably, the shapes of the outer wall 82 of the terminal posts 28, 36 generally mates with the shape of the aperture 72 in the terminal caps 26, 34. Additionally, in one embodiment the outer wall 82 of the terminal posts 28, 36 may have grooves 86. In one embodiment, the terminal posts 28, 36 are press fit or welded in place with the aperture 72 in the respective positive and negative terminal caps 26, 34 as best shown in FIGS. 3 and 4. An opening 88 is provided at a bottom 90 of the terminal posts 28, 36 to provide access to the respective cavities 84 of the terminal posts 28, 36. The terminal posts are provided within the respective first and second apertures in the plate 20.

In one embodiment, as shown in FIGS. 2-4, the positive and negative terminal bases 30, 38 comprise a post 94 and a flange 96 or shoulder 96 extending from an end of the post 94. The post 94 is sized to fit within the cavity 84 of the terminal posts 28, 36 as shown in FIGS. 3 and 4. In one embodiment the post 94 of the terminal bases 30, 38 is press fit within the respective cavity 84 of the terminal posts 28, 36. Further, in one embodiment the positive terminal base 30 is made of aluminum and is the cathode, and the negative terminal base 38 is made of copper and is the anode.

To create the top cap assembly 10, the positive terminal assembly 22 is provided at the first aperture 54 of the plate 20 and the negative terminal assembly 24 is provided at the second aperture 56. As shown in FIGS. 3 and 4, the terminal caps 26, 34 reside adjacent the top surface 50 of the plate 20, the terminal bases 30, 38 reside adjacent the bottom surface 52 of the plate 20, and the terminal posts 28, 36 reside within the respective apertures 54, 56 of the plate 20. Terminal holders 32, 40 are provided to properly seat the terminal assemblies 22, 24, and to provide better sealing between the environment and the interior of the battery 12.

In one embodiment, the terminal holders 32, 40 are made of a plastic or a plastic polymer, such as polypropylene or another engineered resin. As shown in FIGS. 2-4, in a preferred embodiment the terminal holders 32, 40 are an over-molded component that seats and joins the terminal assemblies 22, 24 to the plate 20. In one embodiment, the terminal holders are overmolded around portions of the terminal holders and the plate. In one embodiment, the plate 20 and the terminal assemblies 22, 24 are placed in a mold 100 and the plastic polymer 102 is injected into the mold cavities 104 to create the terminal holders 32, 40. Coloring, pigments or dyes may be added to the plastic polymer, such as red or black, to designate the positive and negative terminals. The over-molded thermoplastic terminal holders 32, 40 provide a mechanical connection for the terminal assemblies 22, 24 to the plate 20, but they also provide an excellent seal around the terminal assemblies 22, 24. Further, the grooves 86 in the outer wall 82 of the terminal posts 28, 36 further assist in the mechanical and sealing connection with terminal holders 32, 40. The terminal holders 32, 40 thus engage the plate 20, terminal caps 26, 34, terminal posts 28, 36 and terminal bases 30, 38. The terminal holders 32, 40 secure the terminal assemblies 22, 24 to the plate 20 without having the terminal assemblies directly contact the plate 20. In one embodiment as shown in FIG. 4, the flange of the first terminal base is a distance from the first raised portion of the plate adjacent the first aperture and the flange of the first terminal base is generally flush with a bottom surface of the plate distal the first raised portion. Similarly, in one embodiment, the flange of the second terminal base is a distance from the second raised portion of the plate adjacent the second aperture and the flange of the second terminal base is generally flush with a bottom surface of the plate distal the second raised portion.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A top cap assembly for a battery comprising:
a plate having a top surface and a bottom surface, the plate having a first aperture for a first terminal assembly and a second aperture for a second terminal assembly, the first aperture extending through the plate from the top surface to the bottom surface, and the second aperture extending through the plate from the top surface to the bottom surface, the plate also having a first raised portion adjacent the first aperture and a second raised portion adjacent the second aperture, the first raised portion and the second raised portion extending away from the top surface of the plate;
the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post;
a first terminal holder to secure the first terminal assembly to the plate without having the first terminal assembly directly contact the plate, wherein the first terminal holder comprises an overmolded thermoplastic that is overmolded around portions of the first terminal holder and portions of the plate;
the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post; and,
a second terminal holder to secure the second terminal assembly to the plate without having the second terminal assembly directly contact the plate, wherein the second terminal holder comprises an overmolded thermoplastic that is overmolded around portions of the second terminal holder and portions of the plate.

2. The top cap assembly of claim 1, wherein the first terminal holder engages the plate, the first terminal cap, the first terminal post, and the first terminal base, and wherein the second terminal holder engages the plate, the second terminal cap, the second terminal post, and the second terminal base.

3. The top cap assembly of claim 1, further comprising a pressure-relief aperture in the plate extending from the top surface through to the bottom surface, and a rupture disc provided in the pressure-relief aperture and connected to the plate.

4. The top cap assembly of claim 3, wherein the pressure-relief aperture is provided between the first aperture and the second aperture.

5. The top cap assembly of claim 1, further comprising a fill aperture in the plate.

6. The top cap assembly of claim 1, wherein the first and second terminal posts have grooves in an outer surface of each terminal post.

7. The top cap assembly of claim 1, wherein the first terminal cap has an aperture, wherein the first terminal post is provided within the aperture in the first terminal cap and secured to the first terminal cap thereat, wherein the second terminal cap has an aperture, and wherein the second terminal post is provided within the aperture in the second terminal cap and secured to the second terminal cap thereat.

8. The top cap assembly of claim 1, wherein the first terminal post has a cavity, wherein the first terminal base has a post and a flange, wherein the post of the first terminal base fits within the cavity of the first terminal post to connect the first terminal base to the first terminal post, wherein the second terminal post has a cavity, wherein the second terminal base has a post and a flange, wherein the post of the second terminal base fits within the cavity of the second terminal post to connect the second terminal base to the second terminal post.

9. The top cap assembly of claim 1, wherein the first terminal base is made of aluminum, and wherein the second terminal base is made of copper.

10. The top cap assembly of claim 8, wherein the flange of the first terminal base is a distance from the first raised portion of the plate adjacent the first aperture and the flange of the first terminal base is generally flush with a bottom surface of the plate distal the first raised portion, and wherein the flange of the second terminal base is a distance from the second raised portion of the plate adjacent the second aperture and the flange of the second terminal base is generally flush with a bottom surface of the plate distal the second raised portion.

11. A top cap assembly for a battery comprising:
a plate having a top surface and a bottom surface, the plate having a first aperture for a first terminal assembly and a second aperture for a second terminal assembly, the first aperture extending through the plate from the top surface to the bottom surface, and the second aperture extending through the plate from the top surface to the bottom surface;
the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post;
a first terminal holder to secure the first terminal assembly to the plate without having the first terminal assembly directly contact the plate, wherein the first terminal holder comprises an overmolded thermoplastic that is overmolded around portions of the first terminal holder and portions of the plate;
the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post;
a second terminal holder to secure the second terminal assembly to the plate without having the second terminal assembly directly contact the plate, wherein the second terminal holder comprises an overmolded thermoplastic that is overmolded around portions of the second terminal holder and portions of the plate; and,
wherein the first terminal holder engages the plate, the first terminal cap, the first terminal post, and the first terminal base, and wherein the second terminal holder engages the plate, the second terminal cap, the second terminal post, and the second terminal base.

12. The top cap assembly of claim 11, wherein the plate has a first raised portion adjacent the first aperture and a second raised portion adjacent the second aperture, the first raised portion and the second raised portion extending away from the top surface of the plate.

13. The top cap assembly of claim 12, wherein the flange of the first terminal base is a distance from the first raised portion of the plate adjacent the first aperture and the flange of the first terminal base is generally flush with a bottom surface of the plate distal the first raised portion, and wherein the flange of the second terminal base is a distance from the second raised portion of the plate adjacent the second aperture and the flange of the second terminal base is generally flush with a bottom surface of the plate distal the second raised portion.

14. The top cap assembly of claim 11, wherein the first and second terminal posts have grooves in an outer surface of each terminal post.

15. The top cap assembly of claim 11, wherein the first terminal cap has an aperture, wherein the first terminal post is provided within the aperture in the first terminal cap and secured to the first terminal cap thereat, wherein the second terminal cap has an aperture, and wherein the second terminal post is provided within the aperture in the second terminal cap and secured to the second terminal cap thereat.

16. The top cap assembly of claim 11, wherein the first terminal post has a cavity, wherein the first terminal base has a post and a flange, wherein the post of the first terminal base fits within the cavity of the first terminal post to connect the first terminal base to the first terminal post, wherein the second terminal post has a cavity, wherein the second terminal base has a post and a flange, wherein the post of the second terminal base fits within the cavity of the second terminal post to connect the second terminal base to the second terminal post.

17. A top cap assembly for a battery comprising:
a plate having a top surface and a bottom surface, the plate having a first aperture for a first terminal assembly, the first aperture extending through the plate from the top surface to the bottom surface;
the first terminal assembly comprising a first terminal cap, a first terminal post, and a first terminal base, wherein the first terminal post is provided within the first aperture, wherein the first terminal cap is provided adjacent the top surface of the plate and is connected to the first terminal post, and wherein the first terminal base is provided adjacent the bottom surface of the plate and is connected to the first terminal post; and,
a first terminal holder to secure the first terminal assembly to the plate without having the first terminal assembly directly contact the plate, wherein the first terminal holder comprises an overmolded thermoplastic that is overmolded around portions of the first terminal holder and portions of the plate, and wherein the first terminal holder engages the plate, the first terminal cap, the first terminal post, and the first terminal base.

18. The top cap assembly of claim 17, further comprising: the plate having a second aperture for a second terminal assembly, the second aperture extending through the plate from the top surface to the bottom surface;
the second terminal assembly comprising a second terminal cap, a second terminal post, and a second terminal base, wherein the second terminal post is provided within the second aperture, wherein the second terminal cap is provided adjacent the top surface of the plate and is connected to the second terminal post, and wherein the second terminal base is provided adjacent the bottom surface of the plate and is connected to the second terminal post; and,
a second terminal holder to secure the second terminal assembly to the plate without having the second terminal assembly directly contact the plate, wherein the second terminal holder comprises an overmolded thermoplastic that is overmolded around portions of the second terminal holder and portions of the plate, wherein the second terminal holder engages the plate, the second terminal cap, the second terminal post, and the second terminal base.

19. The top cap assembly of claim 17, wherein the plate has a first raised portion adjacent the first aperture, the first raised portion extending away from the top surface of the plate.

20. The top cap assembly of claim 19, wherein the flange of the first terminal base is a distance from the first raised portion of the plate adjacent the first aperture and the flange of the first terminal base is generally flush with a bottom surface of the plate distal the first raised portion.
